(19) United States
(12) Patent Application Publication
(10) Pub. No.: US 2012/0080932 A1
(43) Pub. Date: Apr. 5, 2012

(54) RIM

(75) Inventors: Borris ILSE, Mainz (DE); Boris JACOB, Wiesbaden (DE); Bertrand BACH, Wiesbaden (DE)

(73) Assignee: GM GLOBAL TECHNOLOGY OPERATIONS LLC, Detroit, MI (US)

(21) Appl. No.: 13/248,729

(22) Filed: Sep. 29, 2011

(30) Foreign Application Priority Data
Sep. 29, 2010 (DE) 102010046882.7

(51) Int. Cl. B60B 19/10; B60B 3/10

(52) U.S. Cl. 301/6.3; 301/64.101

(57) ABSTRACT

A rim is provided for a motor vehicle wheel that includes, but is not limited to a rim ring for receiving a tire, a rim hub for fastening to a shaft and a plurality of rim struts each connected to the rim ring and to the rim hub. Between each two adjacent rim struts a cooling opening is formed, and the rim hub and/or the rim ring and/or the rim strut includes, but is not limited to at least one fastening for the releasable connection to a flow guide plate for guiding headwind. Because of this, a rim of simple design configuration is created, which with a low aerodynamic resistance makes possible good cooling of a brake unit.

### CROSS-REFERENCE TO RELATED APPLICATION

This application claims priority to German Patent Application No. 102010046882.7, filed Sep. 29, 2010, which is incorporated herein by reference in its entirety.

### TECHNICAL FIELD

The technical field relates to a rim for a motor vehicle wheel with the help of which a tire can be received and connected to a shaft, more preferably driveshaft of a motor vehicle.

### BACKGROUND

Document DE 10 2008 007 690 A1 describes a rim for a motor vehicle having a rim hub and a rim ring connected to the rim hub via rim struts. Between the rim struts, openings are formed which can be wholly or partly closed with the help of plates moveably connected to the rim with the help of an actuating device in order to be able to change the aerodynamic characteristics of the rim while driving. There is a need for achieving good aerodynamics in rims through simple design measures and simultaneously make possible cooling of a brake unit through headwind.

Therefore, it is at least one object to create a rim of simple design that has good aerodynamic characteristic and makes possible cooling of a brake unit. In addition, other objects, desirable features, and characteristics will become apparent from the subsequent summary and detailed description, and the appended claims, taken in conjunction with the accompanying drawings and this background.

### SUMMARY

An embodiment relates to a rim for a motor vehicle tire comprising a rim ring for receiving a tire, a rim hub for fastening to a shaft and a plurality of rim braces connected to the rim hub, wherein between each two adjacent rim struts a cooling opening is formed. The rim hub and/or the rim ring and/or the rim strut comprises/comprise at least one fastening means for the releasable connection to a flow guide plate for guiding headwind.

Through the fastening means for the releasable fastening of flow guide plates it is possible through a measure that can be easily implemented with regard to design to select a flow guide plate from a plurality of different suitable flow guide plates with a configuration that is optimized for the desired purpose. Rims, which are arranged adjacent to a brake unit of a motor vehicle, can conduct headwind for cooling the brake unit with the help of the flow guide plate, while a rim of the same type, with which no brake unit is arranged adjacently, can provide a comparatively low flow resistance with the help of a differently shaped flow guide plate. Because of this, a rim of a simple design configuration is created, which makes possible good cooling of the brake unit with a low aerodynamic resistance. Because of the releasable connection of the flow guide plate to the rim it is possible without difficulties to switch front wheel and rear wheel during a tire change, in order to achieve even wear of the tires, and merely exchange the at least one flow guide plate of the front wheel with the at least one flow guide plate of the rear wheel in order to restore the original aerodynamic optimization of the rims.

The rim ring, the rim strut and the rim hub can more preferably be configured unitarily. Preferentially, the rim ring, the rim strut and the rim hub are produced from a metallic material, preferentially by casting. The rim ring, the rim strut and the rim hub are more preferably predominantly of aluminum or iron and are preferentially alloyed. The flow guide plate can be produced of a metallic material. Preferentially, the flow guide plate is produced from a plastic material, more preferably through plastic injection molding. The rim ring has an edge more preferably standing away radially to the outside at its axial end in order to avoid unintentional slipping off of a received tire. The rim hub can more preferably be screwed to a shaft flange of a motor vehicle. More preferably, the fastening is configured for an insertable clamping connection. Because of this, the flow guide plate can be manually fastened by frictional connection to the fastening means, more preferably without additional tools.

Preferentially, a fastening direction for fastening the flow guide plate to the fastening substantially runs parallel to an axis of rotation of the rim hub. Because of this, the flow guide plate can be fitted onto the rim without difficulties from an easily accessible side through a substantially linear movement, so that an exchange of the flow guide plates in particular is simplified.

Particularly preferably the rim ring has a fastening shoulder standing away radially and facing the rim hub, wherein the fastening shoulder comprises the fastening. Because of this, the fastening shoulder is easily accessible so that a simple assembly of the flow guide plate as well as easy verification of adequate fastening are possible. In particular, the rim ring has a depression running in circumferential direction and/or a strut running in circumferential direction for forming the fastening. Because of this, the flow guide plate can be easily held, more preferably clamped. At the same time an aerodynamically correct orientation of the flow guide plate can be ensured.

Preferentially, the rim strut has a more preferably slit-shaped strut opening for the partial insertion and/or clamping of the flow guide plate. Because of this, the flow guide plate can be hooked and/or clamped to the rim strut and preferentially provide a defined airflow, which is independent of an airflow through the cooling openings. More preferably, the flow guide plate makes possible an air stream through the flow opening which is able to discharge dirt from the interior of the rim via the cooling opening.

More preferably, the rim hub comprises screw openings for receiving rim screws for mounting the rim to a shaft. The screw openings have a depth that is selected so that the flow guide plate can be fastened to the screw opening via frictional connection with the help of a corresponding clamping shoulder. Because of this, the screw openings cannot only make possible the fastening of the rim to a shaft but also provide the fastening for fastening the flow guide plate to the rim.

An embodiment relates to a rim unit for a motor vehicle wheel comprising a rim, which can be designed and further developed as described above, and at least one flow guide plate releasably connected to the rim for guiding headwind. With the help of the rim a rim unit of simple design configuration is created, which with a low aerodynamic resistance makes possible good cooling of the brake unit. In particular, the flow guide plate supports itself on the rim strut upon introducing headwind into the cooling opening. The forces acting on the flow guide plate from the headwind can be removed from the rim strut through a more preferably areal bearing of the flow guide plate against the rim strut.

Preferentially, a first flow guide plate and at least a second flow guide plate are connected respectively to the rim hub and to the rim ring and/or to the rim strut. The first flow guide plate and the second flow guide plate are arranged spaced from each other. Through the multi-part configuration of the flow guide plates the individual flow guide plates can be fastened to the rim via different fastening means in different locations and provide aerodynamic functionalities without mutually interfering with each other significantly. At the same time, the first flow guide plate and the second flow guide plate can be configured in a simple manner in order to be able to provide their intended functions.

More preferably, the first flow guide plate comprises a first flow edge substantially facing radially to the outside and the second flow guide plate a second flow edge substantially facing radially inside. The pitch of the course of the first flow edge at the end spacing to the second flow guide plate merges with the pitch of the force of the second flow edge of the second flow guide plate at the end facing to the first flow guide plate. Through the different flow edges, different flow directions in the interior of the rim can be created depending on the angular position of the rim, wherein through the different functionalities the visual appearance of the rim is not impaired but even improved.

In particular, the flow guide plate is connected with an active control unit for changing the aerodynamic characteristics of the flow guide plate. With the help of the control unit the setting angle of a flow edge of the flow guide plate can be changed in particular so that the aerodynamic characteristics for example can be adjusted as a function of the traveling speed while driving. To this end, the flow guide plate can have hinge components and/or be elastically bent by the control unit.

An embodiment relates to a wheel rim set for a motor vehicle with a first rim unit, which can be designed and further developed as described above, for use as a front wheel and a second rim unit, which can be designed and further developed as described above, for use as a rear wheel. The flow guide plate of the first rim unit is shaped differently to the flow guide plate of the second rim unit. With the help of the different rim units a wheel rim set of simple design configuration is created, which with a low aerodynamic resistance makes possible good cooling of the brake unit. In particular, an aerodynamic characteristic can be achieved for the front wheel that is different to that for the rear wheel.

An embodiment relates to a motor vehicle comprising at least two rim units that can be designed and further developed as described above, and at least one brake unit for the braking of the motor vehicle. With the help of the rim units a motor vehicle of a simple design configuration is created, which with a low aerodynamic resistance provides good cooling of the brake unit. In particular, only that rim unit that is arranged adjacent to the brake unit comprises a second flow guide plate. Since with a rim without adjacent brake unit cooling is not required, the corresponding flow guide plate can be saved, as a result of which the costs are reduced and through the lower weight a Co₂ reduction for the motor vehicle is achieved.

### BRIEF DESCRIPTION OF THE DRAWINGS

The present invention will hereinafter be described in conjunction with the following drawing figures, wherein like numerals denote like elements, and:

FIG. 1 is a schematic exploded view of a rim unit;

FIG. 2 is a schematic top view for the rim unit from FIG. 1;

FIG. 3 is a schematic top view of the rim unit from FIG. 1;

FIG. 4 is a schematic top view of a rim unit for a rear wheel; and

FIG. 5 is a schematic top view of a rim unit for a front wheel.

### DETAILED DESCRIPTION

The following summary and detailed description is merely exemplary in nature and is not intended to limit application and uses. Furthermore, there is no intention to be bound by any theory presented in the preceding background or summary or the following detailed description.

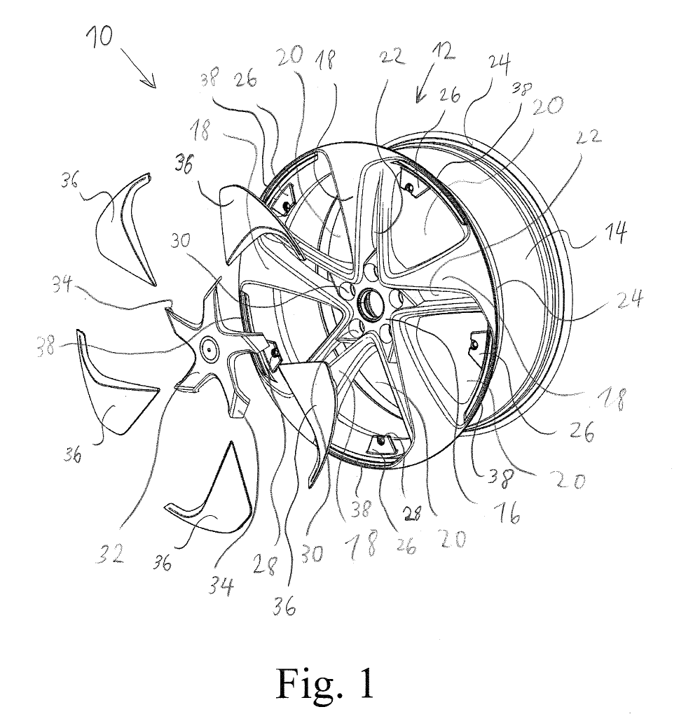

The rim unit 10 shown in FIG. 1 comprises a rim 12 having a rim ring 14 and a rim hub 16. The rim ring 14 is connected preferentially unitarily to the rim hub 16 via more preferably five rim struts 18. Between the rim struts 18, cooling openings 20 are formed in each case. The rim struts 18 preferentially have slit-shaped strut openings 22 substantially running radially. At its axial ends, an edge 24 stands away in each case from the rim ring 14, through which a slipping-off of a tire received by the rim ring 14 is prevented. Furthermore, a fastening shoulder 26 stands away from the rim ring 14 radially to the inside, which forms a fastening means 28 for an insertable clamping connection.

The rim hub 16 has screw openings 30 with the help of which the rim 12 can be screwed to a shaft of a motor vehicle. At the same time, the screw openings 30 are embodied so that they form a fastening for an insertable clamping connection. In the screw openings 30, corresponding shoulders of a first flow guide plate 32 can be inserted, so that the flow guide plate 32 can be clamped to the rim hub 16 by way of frictional connection. More preferably, the flow guide plate 32 can be connected to the rim 12 more substantially in the middle. The first flow guide plate 32 can be preferentially configured substantially star-shaped, so that the first flow guide plate with a first flow edge 34 can be inserted in the strut opening 22 of the rim strut 18 and/or clamped. Spaced from the first flow guide plate 32, a plurality of second flow guide plates 36 can be releasably connected to the rim 12. The second flow guide plates 36 can be connected with the holding shoulder 26 of the rim ring 14. Additionally or alternatively, the second flow guide plate 36 can be inserted in a stabilizing manner in a depression 38 running in circumferential direction. Preferentially, the second flow guide plate 36 bears against the rim strut 18 at least partially, so that forces caused through headwind can be removed from the second flow guide plate 36 to the rim strut 18.

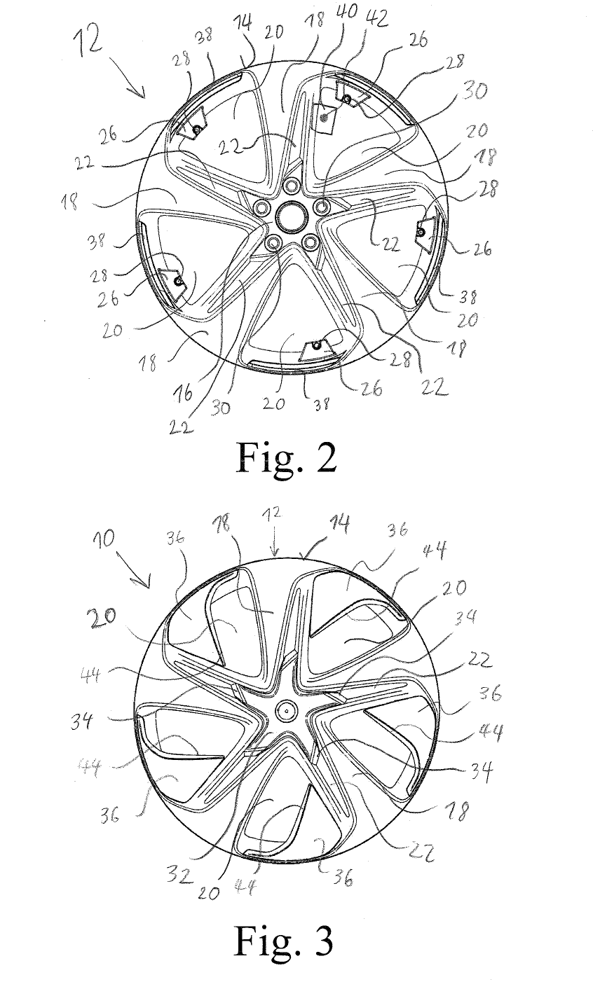

As is evident in FIG. 2, the setting angle of the second flow guide plate 36 can be varied with the help of an active control unit 40. To this end, a pin 42 can for example be extended out of the control unit 40 in axial direction of the rim 12 in order to elastically bend the second flow guide plate 36. As shown in FIG. 3, the second flow guide plate 36 has a second flow edge 44 the orientation of which at its radially inner end corresponds to the radially outer end of the first flow edge 34 of the first flow guide plate 32. Through the second flow guide plate 36, headwind can be conducted into the interior of the rim 12 via the cooling opening 20 in order to cool a brake unit of a motor vehicle that is not shown. Through the rotation of the rim 12 while driving the second flow guide plate 36 can be in a position in which the second flow edge 44 faces away from the driving direction of the motor vehicle, so that no headwind is conducted into the cooling opening 20. In particular, the flow guide plate 36 in this situation is in a lower position in gravitation direction. In this position, the first flow edge 34 of the first flow guide plate 32 is preferentially exposed to the headwind so that headwind can be conducted into the interior of the rim 12 by the first flow guide plate 32 via the strut opening 22. Because of this, a flow is created, which, via the first flow edge 34 of the first flow guide plate 32, is conducted into the interior of the rim 14 and conducted outward via the lower second flow guide plate 36. Through this air stream, dirt within the rim 14 can be automatically discharged so that in particular dirt accumulation on the brake unit and a diminishing of the braking power can be avoided.

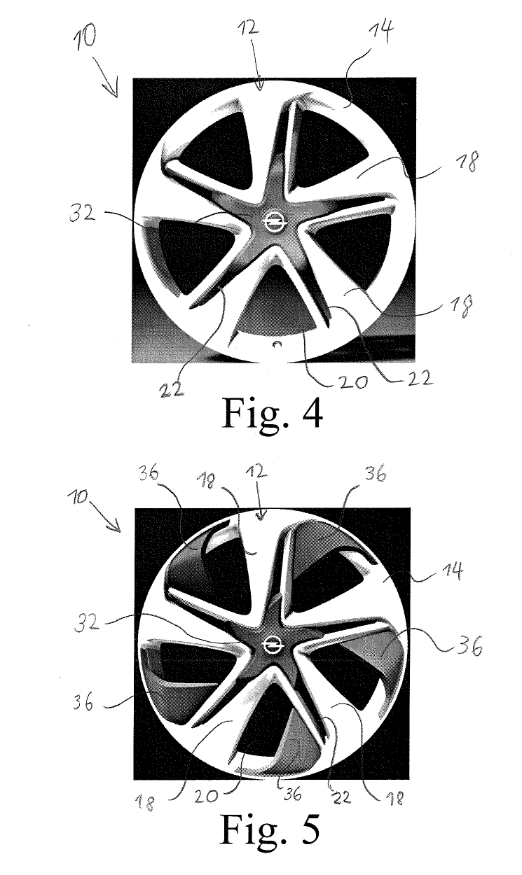

As shown in FIG. 4, the rim unit 10, in the case that the rim 12 is not arranged adjacent to a brake unit can be configured without the second flow guide plates 36. In contrast to this, the rim unit 10 shown in FIG. 5, with which the rim 12 is arranged adjacent to a brake unit, can be provided with the second flow guide plates 36. Because of the different aerodynamic conditions of a front wheel compared to a rear wheel the first flow guide plate 32 can be formed differently so that for the front wheel on the one hand and for the rear wheel on the other hand suitably optimized aerodynamic conditions can be adjusted.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A rim for a motor vehicle wheel, comprising:
a rim ring configured to receive a tire;
a rim hub configured to fasten to a shaft; and
a plurality of rim struts connected to the rim ring and to the rim hub;
a cooling opening formed between adjacent rim struts; and
a fastening configured for a releasable connection to a flow guide plate for guiding headwind.

2. The rim according to claim 1, wherein the fastening an insertable clamping connection.

3. The rim according to claim 1, wherein a fastening direction for fastening the flow guide plate to the fastening substantially runs parallel to an axis of rotation of the rim hub.

4. The rim according to claim 1,
wherein the rim ring comprises a fastening shoulder radially standing away and facing the rim hub, and
wherein the fastening shoulder comprises the fastening.

5. The rim according to claim 1, wherein the rim ring comprises a depression running in circumferential direction running in circumferential direction to form the fastening.

6. The rim according to claim 1, wherein the rim strut comprises a slit-shaped strut opening for partial insertion of the flow guide plate.

7. The rim according to claim 1,
wherein the rim hub comprises screw openings configured to receive rim screws for mounting the rim to a shaft,
wherein the screw openings have a depth that is selected in such a manner that the flow guide plate is fastenable to the screw opening in a frictionally connected manner with assistance of a corresponding clamping shoulder.

8. A rim unit for a motor vehicle wheel, comprising:
a rim comprising:
a rim ring configured to receive a tire;
a rim hub configured to fasten to a shaft; and
a plurality of rim struts connected to the rim ring and to the rim hub;
a cooling opening formed between adjacent rim struts; and
a fastening configured for a releasable connection to a flow guide plate for guiding headwind; and
a flow guide plate releasably connected to the rim and configured to guide headwind.

9. The rim unit according to claim 8, wherein the flow guide plate upon conducting headwind into the cooling opening is supported on the rim strut.

10. The rim unit according to claim 8,
wherein a first flow guide plate is connected to the rim hub, and
a second flow guide plate is connected to the rim ring, AND
wherein the first flow guide plate is spaced apart from the second flow guide place.

11. The rim unit according to claim 10,
wherein the first flow guide plate has a first flow edge substantially facing radially to an outside and the second flow guide plate has a second flow edge substantially facing radially inside, and
wherein a pitch of a course of the first flow edge at an end facing to the second flow guide plate merges into the pitch of a course of a second flow edge of the second flow guide plate at the end facing to the first flow guide plate.

12. The rim unit according to claim 8, further comprising an active control unit configured to change aerodynamic characteristics of the flow guide plate that is connected to the flow guide plate.

13-15. (canceled)

16. The rim according to claim 1, wherein the rim hub comprises the fastening.

17. The rim according to claim 1, wherein the rim ring comprises the fastening.

18. The rim according to claim 1, wherein the rim strut comprises the fastening.
